(19) United States
(12) Patent Application Publication
(10) Pub. No.: US 2003/0123653 A1
(43) Pub. Date: Jul. 3, 2003

(54) Hands free phone holding device

(76) Inventor: Kathleen DiScenna, Oswego, NY (US)

Correspondence Address: HANCOCK & ESTABROOK, LLP, 1500 MONY Tower I, PO Box 4976, Syracuse, NY, 13221-4976, US

(21) Appl. No.: 10/040,232

(22) Filed: Jan. 2, 2002

(51) Int. Cl. H04M 1/00

(52) U.S. Cl. 379/455

(57) ABSTRACT

The present invention provides a hands free unit for operating a telephone generally comprising a headband and a boom arm pivotally interconnected to the headband. The boom arm includes a strip of pile fabric adhered to its terminal end. A phone having a strip of loop fabric adhered to its rear surface may be interconnected to the boom arm by overlaying the pile fabric and loop fabric. In use, a user may positioned the headband on his/her head, attach the phone to the boom arm, and pivotally move the boom arm such that the microphone of the phone is positioned adjacent his/her mouth.

### BACKGROUND OF THE PRESENT INVENTION

The present invention relates generally to hands free devices for operating phones, and more particularly to such devices that may be worn on the head of a user.

Cellular phone use has increased dramatically as the infrastructure and technology have developed bringing the cost and utility of such phones within the reach of most people. Typically, such phones are used in a mobile setting, such as when driving in the car or walking somewhere, i.e., not necessarily when sitting at home. Thus, the typical use of these phones occurs simultaneously with the user performing some other task which requires his/her concentration. Therefore, there is an increased risk that the user will have a lower level of concentration relative to each of the tasks being performed simultaneously, i.e., driving a car and talking on the phone. Obviously, the consequences of decreased concentration of driving a car could be drastic.

In addition to the diminishing amount of concentration people are able to give individual tasks when performing them simultaneously, the risks are amplified when each of the multiple tasks also require use of the user's hands, such as holding the steering wheel or shifter of a car and holding onto a phone. For instance, if a user must hold the steering wheel of the car with one hand, shift the car into a different gear with the other hand, he/she must hold the phone between his/her head and shoulder. Such an anatomical arrangement prevents the user from fully seeing the road and other obstacles one may encounter when driving.

It is therefore a principal object and advantage of the present invention to provide a device that permits a user to operate a phone without use of his/her hands and without requiring additional concentration other than that needed to speak on the phone.

It is another object and advantage of the present invention to provide a hands free phone device that is easily and inexpensively manufactured.

It is a further object and advantage of the present invention to provide a hands free phone device that may be used with practically any style of cellular or cordless phone on the market.

Other objects and advantages of the present invention will in part be obvious, and in part appear hereinafter.

### SUMMARY OF THE INVENTION

In accordance with the foregoing objects and advantages, the present invention provides a hands free unit for operating a telephone generally comprising a headband and a boom arm pivotally interconnected to the headband. The boom arm includes a strip of pile fabric adhered to its terminal end. A phone having a strip of loop fabric adhered to its rear surface may be interconnected to the boom arm by overlaying the pile fabric and loop fabric. In use, a user may positioned the headband on his/her head, attach the phone to the boom arm, and pivotally move the boom arm such that the microphone of the phone is positioned adjacent his/her mouth.

### BRIEF DESCRIPTION OF THE DRAWING FIGURES

The present invention will be more fully understood and appreciated by reading the following Detailed Description in conjunction with the accompanying drawings, in which:

FIG. 1 is a perspective view of the present invention in use;

FIG. 2 is an exploded perspective view of te present invention;

FIG. 3 is a top plan view thereof;

FIG. 4 is a front elevation view thereof;

FIG. 5 is a fragmentary side elevation view thereof;

FIG. 6 is a cross-sectional view taken along Section Line 6-6 of FIG. 3;

FIG. 7 is a fragmentary top plan view of the boom portion of the present invention;

FIG. 8 is a side elevation view of the boom portion of the present invention;

FIG. 9 is a front elevation of the boom portion of the present invention;

FIG. 10 is a view of the boom portion of the present invention taken along View Line 10-10 of FIG. 9;

FIG. 11 is a front elevation view of the pivot pin of the present invention;

FIG. 12 is a bottom plan view of the pivot pin of the present invention;

FIG. 13 is a rear elevation view illustrating an example of a first type of phone with which the present invention will work, and showing a sleeve in spaced relation thereto; and

FIG. 14 is a rear elevation view illustrating an example of a second type of phone with which the present invention will work, and showing a sleeve in spaced relation thereto.

### DETAILED DESCRIPTION

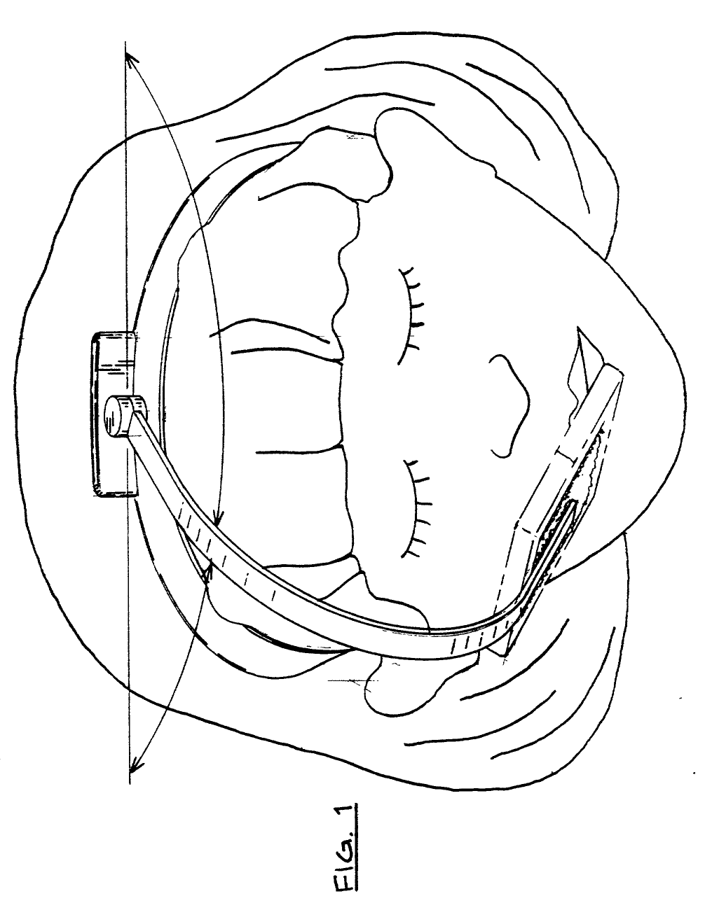

Referring now to the drawings, in which like reference numerals refer to like parts throughout, there is seen in FIG. 1 a hands free unit, designated generally by reference numeral 10, worn by a user 12 for hands free talking on a phone 14, such as a cellular of cordless phone.

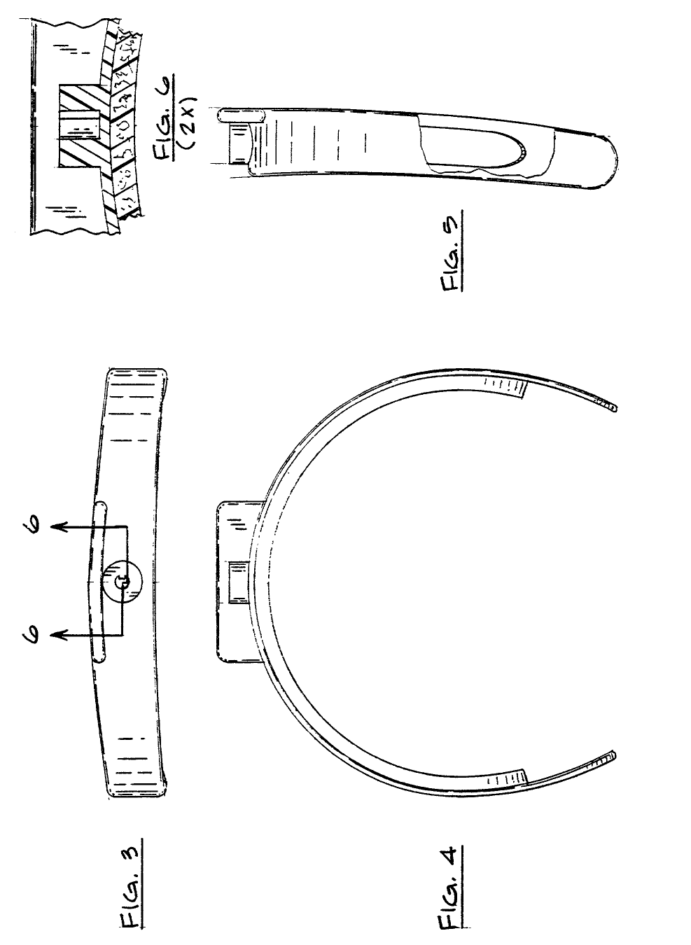

With reference to FIGS. 2-6, hands free unit 10 generally comprises a headband 16 and a boom arm 18 pivotally interconnected to headband 16. More specifically, headband 16 comprises a U-shaped band 20 adapted to contour the head of a user 12, a pad 22, such as composed of foam or other soft material, adhered to the inwardly facing surface of band 20 so as to provide comfort to the user 12, a boss 24 extending upwardly from the outwardly facing surface of band 20 at about its midpoint M, and a rib 26 extending upwardly from the outwardly surface of band 20 and spanning a medial region thereof for reasons that will be explained in greater detail hereinafter.

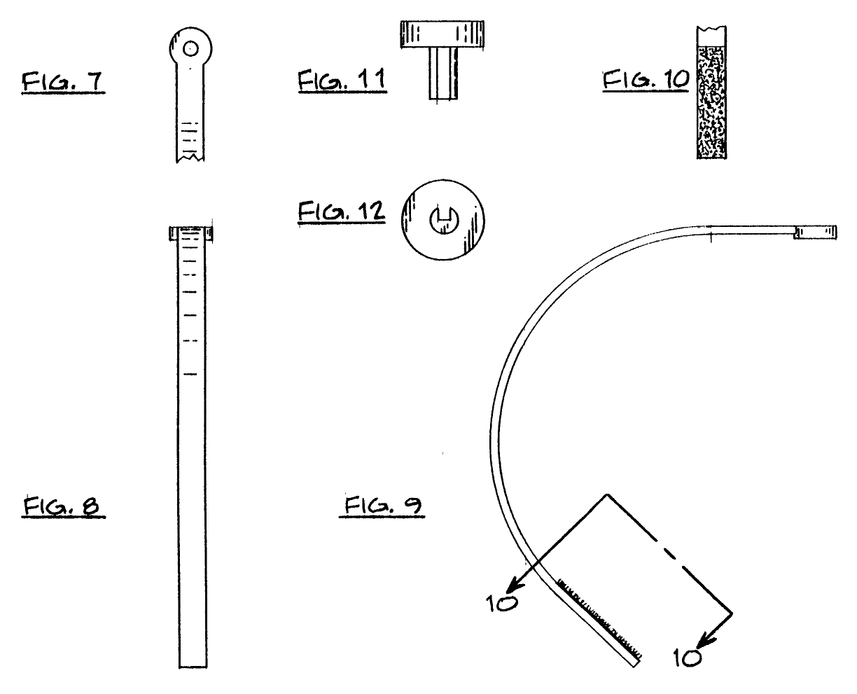

With reference to FIGS. 7-12, boom arm 18 comprises a curved, elongated member having a first end 28 that includes an opening 30 formed therethrough and a spacer 31 extending downwardly thereform (opening 30 also extends through spacer 31), and a second end 32 from which a strip of pile fabric (e.g., VELCRO®) 34, or equivalent material, extends over a predetermined length, e.g., two inches, on the inwardly facing surface of the member. A pin 36 passes through opening 30 and engages boss 24, thereby pivotally interconnecting boom arm 18 to headband 16. A sleeve 38 may be removably positioned in covering relation to VELCRO 34 when unit 10 is not in use so as to protect against premature degradation of the VELCRO, and prevent the VELCRO from inadvertently adhering to another object.

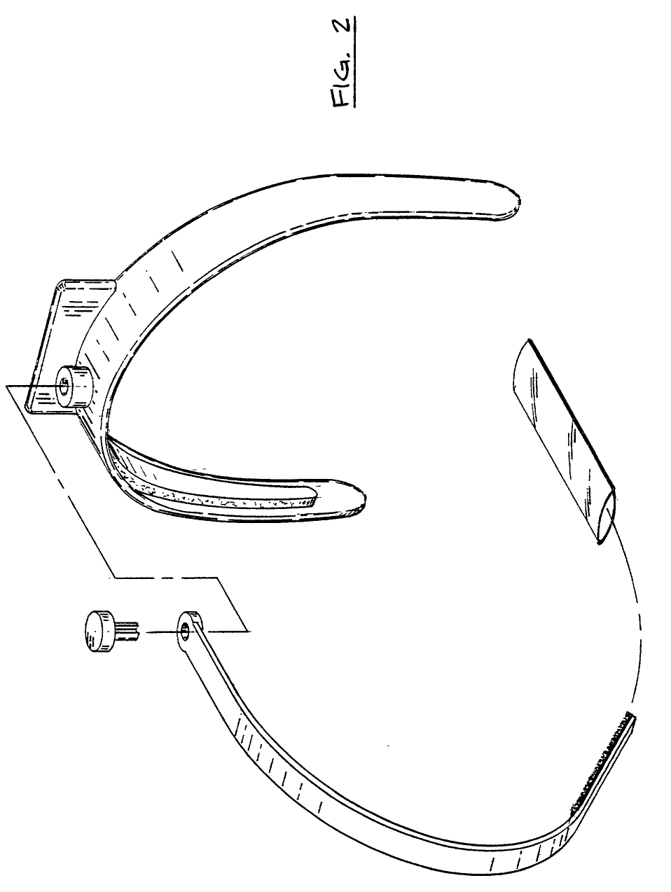

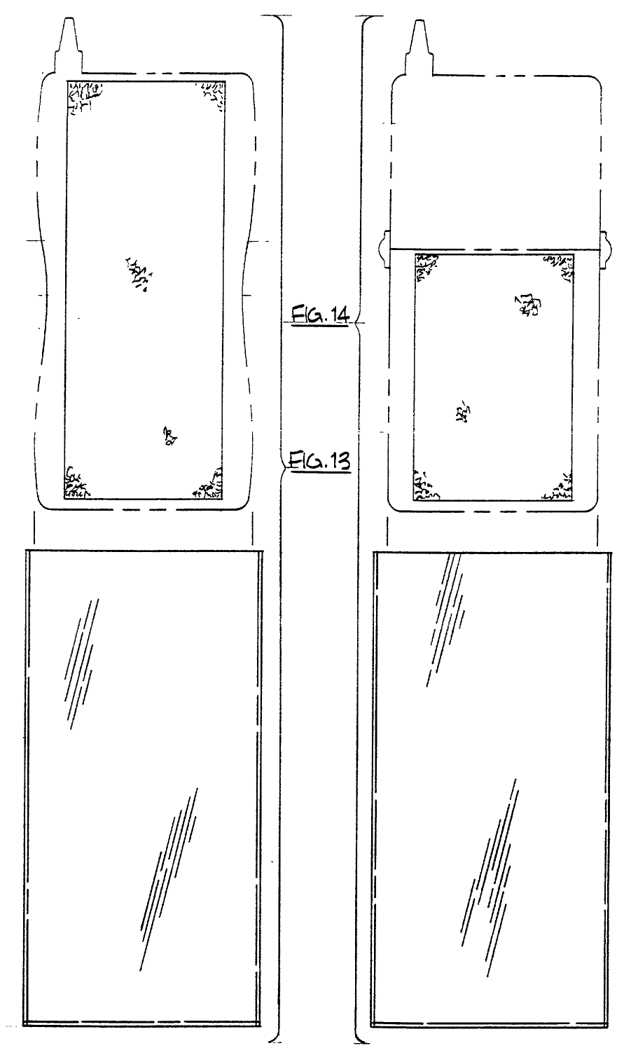

To prevent pin 36 from rotating while boom arm 18 rotates, its shaft is provided with a notch 40 (see FIG. 12) that aligns with a corresponding notch 42 formed in boss 24 (see FIG. 3).

In use, user 12 would position headband 16 comfortably on his/her head, and attach a phone 14 to boom arm 18 by overlaying a strip of loop fabric 44, or equivalent material, adhered to the rear surface of phone 42 to pile fabric 34 (the type of materials 34 and 44 selected is unimportant so long as the two materials are adhesively associated with one another, i.e., they permit interconnection). Boom arm 18 may then be pivotally moved about the axis of pivot pin 36 until the microphone portion of phone 42 is positioned adjacent the user's mouth. When not in use, boom arm 18 may be pivotally moved away from the face of user 12. Rib 26, however, prevents movement of boom arm 18 behind the head of user 12, thereby maintaining stability of unit. Spacer 31 prevents friction from occurring between headband 16 and boom arm 18 as they are moved relative to one another.

With reference to FIGS. 13 and 14, unit 10 can be used with practically any style of phone, such as a conventional phone 14a (FIG. 13) or a flip style phone 14b (FIG. 14), although it is intended to be used with mobile/cellular phones so as to provide a user with hands free capability while driving. Of course, the type of phone is unimportant as is the reason for using the present invention, and the scope of the present invention should extend to its full spirit and scope as defined by the appended claims.

1. A hands free device for holding a phone having front and rear surfaces and a strip of first material attached to its rear surface, said device comprising:
a. a generally U-shaped headband having inwardly and outwardly facing surfaces, first and second ends, and a midpoint; and
b. a boom arm having first and second ends, and being pivotally interconnected to the midpoint of said headband at its said first end, and including a strip of second material attached thereto and extending from said second end, said second material being adhesively associated with said first material.

2. The hands free device of claim 1, further comprising a spacer element attached to said first end of said boom arm and positioned between said boom arm and said headband.

3. The hands free device of claim 1, further comprising a rib attached to and extending outwardly from said headband and spanning said midpoint.

4. The hands free device of claim 1, wherein said first material is selected from the group consisting of loop fabric and pile fabric.

5. The hands free device of claim 1, where in said second material is selected from the group consisting of loop fabric and pile fabric.

6. The hands free device of claim 1, further comprising a pin that interconnects said headband to said boom arm.

7. The hands free device of claim 6, further comprising a boss attached to said outwardly facing surface of said headband and positioned at its said midpoint.

8. The hands free device of claim 7, wherein said pin includes a shaft portion that includes a first notch formed therein, and said boss includes a second notch formed therein, and said pin engages said boss with said first notch engaging said second notch.

9. The hands free device of claim 1, further comprising a pad attached to said inwardly facing surface of said headband.

10. The hands free device of claim 1, further comprising a sleeve removably engaging said second end of said boom arm in covering relation to said second material.
